(19) United States
(12) Patent Application Publication
(10) Pub. No.: US 2025/0140106 A1
(43) Pub. Date: May 1, 2025

(54) METHOD AND SYSTEM FOR GENERATING REFERENCE DATA FOR TRAFFIC CONDITION PREDICTION, AND METHOD AND SYSTEM FOR PREDICTING TRAFFIC CONDITIONS

(71) Applicant: Telecom Italia S.p.A., Milano (IT)

(72) Inventors: Davide MICHELI, Roma (IT); Aldo VANNELLI, Roma (IT)

(73) Assignee: Telecom Italia S.p.A., Milano (IT)

(21) Appl. No.: 18/690,271

(22) PCT Filed: Sep. 2, 2022
(86) PCT No.: PCT/IB2022/058250

§ 371 Date: Mar. 8, 2024

(30) Foreign Application Priority Data
Sep. 8, 2021 (IT) 102021000023144

(51) Int. Cl. G08G 1/01; G08G 1/052

(52) U.S. Cl. CPC G08G 1/0133; G08G 1/052

(57) ABSTRACT

A method, system, and devices for generating reference data for traffic condition prediction. The method includes determining a zone of interest and a detection zone associated with the zone of interest and detecting the presence of a plurality of mobile terminals in the detection zone. Based on at least a first movement feature of the user terminals, calculating one or more predictors associated with geographical positions of the user terminals, receiving a traffic signal representative of an objective traffic condition in said zone of interest, and determining reference data, based on the calculated predictors and the objective traffic condition, for correlating the predictors and the objective traffic condition.

### BACKGROUND OF THE INVENTION

### Field of the Invention

The present invention refers to a method for generating reference data for traffic condition prediction.

The present invention also refers to a system for generating reference data for traffic condition prediction.

The present invention also refers to a method for predicting traffic conditions.

The present invention also refers to a system for predicting traffic conditions.

### Description of the Related Art

As known, knowing and predicting traffic conditions is extremely useful, both for avoiding wasting of time and reducing the likelihood of accidents (in case of car traffic).

Some methods are currently used to this aim, which are based on statistical behavior of people movement (e.g., traditionally, in Italy, August weekends are characterized by an extremely congested traffic to/from touristic locations) and/or on information based on reservations for touristic places.

However, these methods show clear limits, as they cannot be particularly accurate.

Document WO 2004/027729 discloses a method and system for detecting and estimating road traffic from location data of mobile terminals in a radiocommunication system.

Article “Freeway Short-Term Travel Speed Prediction Based on Data Collection Time-Horizons: A Fast Forest Quantile Regression Approach” by Zahid et al., published on MDPI (Multidisciplinary Digital Publishing Institute)—https://www.mdpi.com/2071-1050/12/2/646, discloses an analysis of the prediction performance of fast forest quantile regression in the context of traffic prediction.

Book “Road Traffic Estimation using Cellular Network Signaling in Intelligent Transportation Systems” by Gundlegård et al, Nova Science Publishers, ISBN: 978-1-60741-588-6, discloses techniques for obtaining road traffic information based on cellular network data.

Article “Review of traffic data estimations extracted from cellular networks” by Caceres et al., published in IET Intelligent Transport Systems, DOI: 10.1049/iet-its: 20080003 (available at the following address: https://digital-library.theiet.org/content/journals/10.1049/iet-its_20080003), discloses how to obtain parameters related to traffic from cellular-network-based data, describing methods used in simulation works as well as field tests in the academic and industrial field.

Document WO 2009/080105 A1 discloses a method and a system for estimating road traffic.

Document WO 2020/002094 A1 discloses a method and a system for traffic analysis.

In view of the above, the Applicant has felt the need to arrange a new technology for traffic prediction (be it pedestrian traffic or vehicle traffic), which could be accurate, reliable, and independent from the specific circumstances that might influence the traffic.

### SUMMARY OF THE INVENTION

A first aspect of the present invention refers to a method for generating reference data for traffic condition prediction.

In an embodiment of the present invention, the method for generating reference data for traffic condition prediction comprises determining a zone of interest.

In an embodiment of the present invention, the method for generating reference data for traffic condition prediction comprises determining a detection zone.

In an embodiment of the present invention, the detection zone is associated to the zone of interest.

In an embodiment of the present invention, the method for generating reference data for traffic condition prediction comprises detecting the presence of a plurality of first devices in said detection zone.

In an embodiment of the present invention, said first devices are mobile user terminals.

In an embodiment of the present invention, the method for generating reference data for traffic condition prediction comprises, for each of said first devices, receiving over time a plurality of first report signals.

In an embodiment of the present invention, each first report signal includes a geographical position of said first device.

In an embodiment of the present invention, each first report signal included a time reference associated with said geographical position.

In an embodiment of the present invention, each first report signal includes at least one of a user-related identifier and a session identifier.

In an embodiment of the present invention, the user-related identifier is a temporary identifier.

In an embodiment of the present invention, the method for generating reference data for traffic condition prediction comprises, for each of said first devices, determining, based on said first report signals, one or more movement features correlated to movement of said first device in said detection zone.

In an embodiment of the present invention, the method for generating reference data for traffic condition prediction comprises calculating, based on said one or more movement features of said first devices, one or more predictors, associated to said time references and said geographical positions.

In an embodiment of the present invention, the method for generating reference data for traffic condition prediction comprises receiving a traffic signal.

In an embodiment of the present invention, the traffic signal is representative of an objective traffic condition in said zone of interest.

In an embodiment of the present invention, said objective traffic condition has occurred after a determined time with respect to said one or more of time references.

In an embodiment of the present invention, the method for generating reference data for traffic condition prediction comprises determining reference data, based on said calculated predictors and said objective traffic condition.

In an embodiment of the present invention, said reference data correlate said predictors and said objective traffic condition.

In an embodiment of the present invention, the method for generating reference data for traffic condition prediction comprises storing said reference data in in a first memory.

In an embodiment of the present invention, said first report signals are Minimization of Drive Test, MDT, signals.

In an embodiment of the present invention, said first report signals are generated based on Minimization of Drive Test, MDT, signals.

In an embodiment of the present invention, said one or more movement features include the speed at which each first device moves in said detection zone.

In an embodiment of the present invention, said one or more movement features include a trajectory along which each first device moves.

In an embodiment of the present invention, said one or more predictors comprise an average speed of said first devices.

In an embodiment of the present invention, said one or more predictors comprise a variance of the speed of said first devices.

In an embodiment of the present invention, the correlation between said one or more predictors and possible traffic conditions in said zone of interest is established via a machine learning tool.

A second aspect of the present invention refers to a method for predicting traffic conditions.

In an embodiment of the present invention, the method for predicting traffic conditions comprises determining a zone of interest.

In an embodiment of the present invention, the method for predicting traffic conditions comprises determining a path to said zone of interest.

In an embodiment of the present invention, the method for predicting traffic conditions comprises providing, in a memory, reference data.

In an embodiment of the present invention, said reference data correlate predictors associated to possible movement features of mobile terminals in said detection zone at a first time, with possible traffic conditions in said zone of interest at a second time.

In an embodiment of the present invention, said second time occurs after a determined time with respect to said first time.

In an embodiment of the present invention, the method for predicting traffic conditions comprises detecting the presence of a plurality of second devices in said detection zone.

In an embodiment of the present invention, said second devices are mobile user terminals.

In an embodiment of the present invention, the method for predicting traffic conditions comprises, for each of said second devices, receiving over time a plurality of second report signals.

In an embodiment of the present invention, each second report signal includes a geographical position of said second device.

In an embodiment of the present invention, each second report signal includes a time reference associated with said geographical position.

In an embodiment of the present invention, each second report signal includes at least one of a user-related identifier and a session identifier.

In an embodiment of the present invention, the user-related identifier is a temporary identifier.

In an embodiment of the present invention, the method for predicting traffic conditions comprises, for each of said second devices, determining, based on said second report signals, one or more movement features correlated to movement of said second device in said detection zone.

In an embodiment of the present invention, the method for predicting traffic conditions comprises calculating, based on said one or more movement features of said second devices, detection data corresponding to said one or more predictors, associated to said time references and said geographical positions.

In an embodiment of the present invention, the method for predicting traffic conditions comprises processing said detection data based on said reference data, obtaining a prediction of a traffic condition in said zone of interest at a time occurring after a determined time with respect to the time references included in said second report signals.

In an embodiment of the present invention, the method for predicting traffic conditions comprises generating a data signal representative of said predicted traffic condition.

In an embodiment of the present invention, said second report signals are Minimization of Drive Test, MDT, signals.

In an embodiment of the present invention, said second report signals are generated based on Minimization of Drive Test, MDT, signals.

In an embodiment of the present invention, said one or more movement features include a trajectory along which each second moves.

In an embodiment of the present invention, said one or more movement features include the speed at which each second device moves in said detection zone.

In an embodiment of the present invention, possible traffic conditions in said zone of interest are represented by two or more labels.

In an embodiment of the present invention, obtaining a prediction of the traffic condition comprises selecting a label of said two or more labels.

In an embodiment of the present invention, said detection data comprise an average speed of said second devices.

In an embodiment of the present invention, said detection data comprise a variance of the speed of said second devices.

In an embodiment of the present invention, said reference data are determined performing said method for generating reference data for traffic condition prediction.

In an embodiment of the present invention, the method for predicting traffic conditions comprises sending said data signal to a display installed in an area associated with said detection zone.

In an embodiment of the present invention, the method for predicting traffic conditions comprises sending said data signal to mobile devices in an area associated with said detection zone.

In an embodiment of the present invention, the method for predicting traffic conditions comprises sending said data signal to a traffic management system associated with said zone of detection and/or with said zone of interest.

In an embodiment of the present invention, the method for predicting traffic conditions comprises determining a suggested speed for mobile devices in an area associated with the detection zone.

In an embodiment of the present invention, the method for predicting traffic conditions comprises including said suggested speed in said data signal.

A third aspect of the present invention refers to a system for generating reference data for traffic condition prediction.

In an embodiment of the present invention, the system for generating reference data for traffic condition prediction comprises a first memory.

In an embodiment of the present invention, the system for generating reference data for traffic condition prediction comprises a first processing unit.

In an embodiment of the present invention, said first processing unit is coupled to said first memory.

In an embodiment of the present invention, said first processing unit is configured for determining a zone of interest.

In an embodiment of the present invention, said first processing unit is configured for determining a detection zone associated to said zone of interest.

In an embodiment of the present invention, said first processing unit is configured for detecting the presence of a plurality of first devices in said detection zone.

In an embodiment of the present invention, said first devices are mobile user terminals.

In an embodiment of the present invention, said first processing unit is configured for receiving over time, for each of said first devices, a plurality of first report signals.

In an embodiment of the present invention, each first report signal includes a geographical position of said first device.

In an embodiment of the present invention, each first report signal includes a time reference associated with said geographical position.

In an embodiment of the present invention, each first report signal includes at least one of a user-related identifier and a session identifier.

In an embodiment of the present invention, the user-related identifier is a temporary identifier.

In an embodiment of the present invention, said first processing unit is configured for determining, for each of said first devices, based on said first report signals, one or more movement features correlated to movement of said first device in said detection zone.

In an embodiment of the present invention, said first processing unit is configured for calculating, based on said one or more movement features of said first devices, one or more predictors, associated to said time references and said geographical positions.

In an embodiment of the present invention, said first processing unit is configured for receiving a traffic signal, representative of an objective traffic condition in said zone of interest.

In an embodiment of the present invention, said objective traffic condition has occurred after a determined time with respect to said one or more of time references.

In an embodiment of the present invention, said first processing unit is configured for determining reference data, based on said calculated one or more predictors and said objective traffic condition.

In an embodiment of the present invention, said reference data correlate said one or more predictors and said objective traffic condition.

In an embodiment of the present invention, said first processing unit is configured for storing in said first memory said reference data.

A fourth aspect of the present invention refers to a system for predicting traffic conditions.

In an embodiment of the present invention, the system for predicting traffic conditions comprises a second memory.

In an embodiment of the present invention, the system for predicting traffic conditions comprises a second processing unit.

In an embodiment of the present invention, said second processing unit is coupled to said second memory.

In an embodiment of the present invention, said second processing unit is configured for determining a zone of interest.

In an embodiment of the present invention, said second processing unit is configured for determining a detection zone associated to said zone of interest.

In an embodiment of the present invention, said second memory contains reference data.

In an embodiment of the present invention, said reference data correlate predictors associated to possible movement features of mobile devices in said detection zone at a first time, with possible traffic conditions in said zone of interest at a second time.

In an embodiment of the present invention, said second time occurs after a determined time with respect to said first time.

In an embodiment of the present invention, said second processing unit is configured for detecting the presence of a plurality of second devices in said detection zone.

In an embodiment of the present invention, said second devices are mobile user terminals.

In an embodiment of the present invention, said second processing unit is configured for receiving over time, for each of said second devices, a plurality of second report signals.

In an embodiment of the present invention, each second report signal includes a geographical position of said second device.

In an embodiment of the present invention, each second report signal includes a time reference associated with said geographical position.

In an embodiment of the present invention, each second report signal includes at least one of a user-related identifier and a session identifier.

In an embodiment of the present invention, the user-related identifier is a temporary identifier.

In an embodiment of the present invention, said second processing unit is configured for determining, based on said second report signals, one or more movement features correlated to movement of said second device in said detection zone.

In an embodiment of the present invention, said second processing unit is configured for calculating, based on said one or more movement features of said second devices, detection data corresponding to said one or more predictors, associated to said time references and said geographical positions.

In an embodiment of the present invention, said second processing unit is configured for processing said detection data based on said reference data, obtaining a prediction of a traffic condition in said zone of interest at a time occurring after a determined time with respect to the time references included in said second report signals.

In an embodiment of the present invention, said second processing unit is configured for generating a data signal representative of said predicted traffic condition.

### BRIEF DESCRIPTION OF THE DRAWINGS

Further features and advantages will appear more clearly from the detailed description of preferred and non-exclusive embodiments of the invention. This description is provided hereinafter with reference to the accompanying illustrative and non-limiting figures, in which:

FIG. 1 schematically shows a block diagram of an environment wherein the invention can be implemented;

FIG. 2 schematically shows a block diagram of a system according to embodiments of the present invention;

FIGS. 3a-3b show block diagrams of a possible implementation of a subpart of the system of FIG. 2;

FIG. 4 schematically show a graphic representation of data used in embodiments of the present invention;

FIGS. 5a-5c schematically represent possible configurations of zones in which the invention can be carried out.

### DESCRIPTION OF EMBODIMENTS OF THE PRESENT INVENTION

According to the present invention, a technique for generating reference data for traffic condition prediction is disclosed hereinafter, along with a technique for predicting traffic conditions.

The Applicant preliminarily observers that, in the present context, “traffic” refers to presence and movement of persons, vehicles, etc.

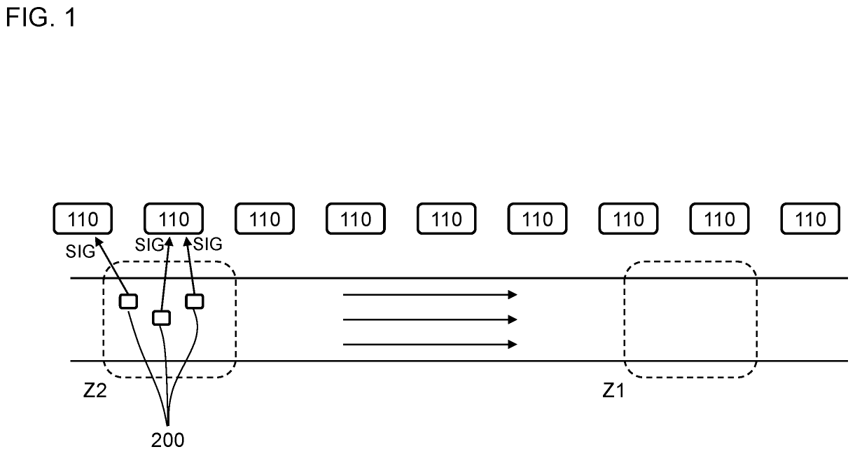

In a nutshell, the invention disclosed herein allows to predict traffic conditions that will occur at a certain time, in zone of interest Z1, based on the traffic detected in a detection zone Z2, in advance with respect to said certain time (FIG. 1).

The detection zone Z2 is preferably at least partly distinct from the zone of interest Z1.

Preferably, the detection zone Z2 is completely distinct from the zone of interest Z1.

Preferably, the detection zone Z2 comprises, is comprised in, or consists of a route to, the zone of interest Z1.

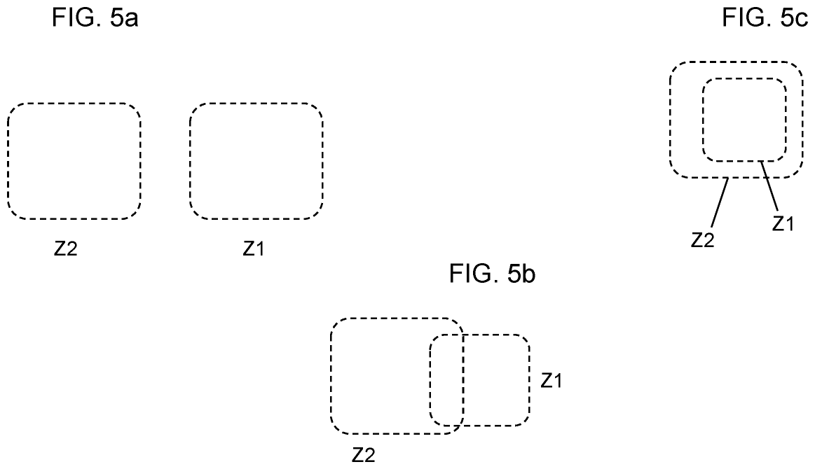

FIGS. 5a-5c represent some of the possible mutual relationships between the zone of interest Z1 and the detection zone Z2.

For example, the detection zone Z2 can be a section of highway, and the zone of interest Z1 can be a position on the same highway, at a certain distance from the detection zone Z2.

In a different example, the detection zone Z2 can be a certain walking area in a city, and the zone of interest Z1 can be a different walking area, in the same city, connected to the detection zone Z2.

Thus, initially, the method according to the present invention preferably envisages a step of determining a zone of interest Z1.

The zone of interest Z1 can have dimensions from a few hundreds of meters to several kilometers, depending on the analysis to be performed.

Within the zone of interest Z1, the presence of mobile devices is detected.

Such detection is carried out based on signalling between each of said mobile devices and the telecommunications network to which the terminals are connected.

For example, the telecommunications network can be a cellular network, employing the 4G technology or the 5G technology. It has to be underlined that the invention can also be applied in other cellular networks.

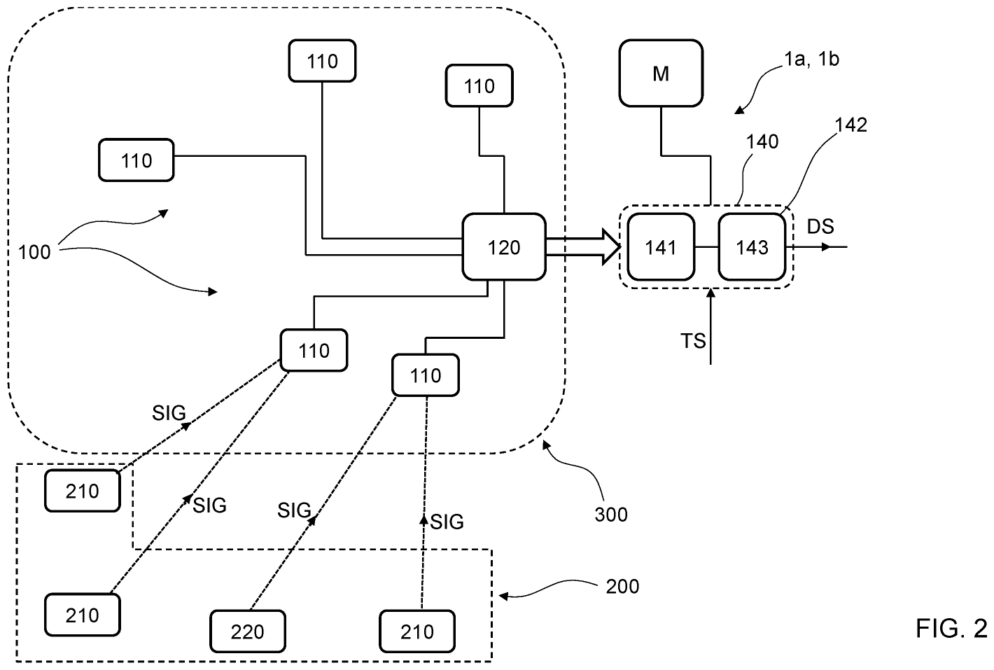

The network (which is denoted at 100 in FIG. 2 and will be disclosed in greater detail in the following) receives from each mobile device, over time, a plurality of information signals SIG.

Each information signal includes a geographical position of the mobile device. For example, the position can be expressed in terms of GPS coordinates. The geographical position can be obtained through a positioning module (such as a GPS module) included in each mobile device.

It has to be noted that, although specific reference has been made to the GPS system, any suitable position detection system can be used (e.g. Galileo system, GLONASS, etc.); generally speaking, a GNSS (Global Navigation Satellite System) can be used. In addition or as an alternative, position detection techniques based on cellular network data can be employed.

Each information signal SIG includes a time reference associated with the geographical position. The time reference is also referred to as Timestamp. The time reference indicates the date (preferred format: dd-mm-yyyy, i.e. two digits indicating the day, two digits indicating the month and four digits indicating the year) and time (preferred format: hh:mm:ss.cc, i.e.: two digits indicating the hour, two digits indicating the minutes, two digits indicating the seconds and two digits indicating the hundredths of seconds) on which the geographical position has been detected.

Each information signal includes at least one of a user-related identifier and a session identifier.

In an embodiment, the user-related identifier is a temporary identifier.

The temporary identifier is an identifier that is randomly allocated to a mobile device when it connects to the network. In 4G networks, for example, such temporary identifier is referred to as TMSI—Temporary Mobile Subscriber Identity. The temporary identifier replaces the IMSI (International Mobile Subscriber Identity) in communications with the network, so as to limit the possibility that eavesdroppers detect the IMSI. As known, IMSI uniquely identifies a subscription in a mobile network. IMSI is stored in the SIM module installed in each mobile device. IMSI is initially sent from the mobile device to the network for checking the user's data in the HLR (Home Location Register); IMSI can be locally copied in the VLR (Visitor Location Register). In signalling, IMSI is used as rarely as possible, to protect its privacy. As said, it is replaced by a temporary identifier, such as the TMSI. Association between IMSI and the respective TMSI is stored in the core network. TMSI is allocated at each new connection, out- to in-coverage transition, turn-on of a user terminal or when a change of access network occurs. TMSI remains allocated without being changed as long as the access network remains the same, even in case of handover—until a change of Location Area or Tracking Area occurs.

It may also be envisaged that the user-related identifier is the IMSI, i.e. a non-temporary identifier. In this case, in order to address privacy issues, consent to use of personal data may be requested to users. In addition or as an alternative, data anonymization techniques can be adopted. The Applicant observes that the use of IMSI allows better precision and accuracy in reconstruction of the trajectories of the mobile devices: on one hand, IMSI permits to reliably associate each report signal with the respective mobile device, so that a higher number or geographical positions (each contained in a respective report signal) of a given mobile device can be employed to define its trajectory-whereas, using TMSI/session identifier, certain report signals cannot be associated to a specific mobile device with a reasonable certainty, and have consequently to be discarded; on the other hand, IMSI permits to track each mobile device with better continuity, for example in case of change of radio access technology-consider, for example, a mobile device connected to a 4G network in a first part of its trajectory; then the mobile device switches to a 3G network in a second part of its trajectory, and finally it connects again to the 4G network in a third part of its trajectory; in this scenario, IMSI allows not to lose continuity in tracking such device, the change of radio access technology notwithstanding, whereas TMSI necessarily changes in the second and in the third part, so that the three parts of the trajectory cannot be associated to the same mobile device.

The session identifier is an identifier of a session (e.g. a call, an SMS exchange, application data exchange, etc.) generated by a determined mobile device, based on a determined subscription, in a determined time period. Preferably, the time period is defined by the MNO (Mobile Network Operator) according to the legislation in force regarding privacy. During the session, the device typically sends multiple information signals, each including the same session identifier. The frequency at which the information signals are generated during a session is preferably defined by the MNO. In particular, the MNO determines a reasonable trade-off between accuracy of information (obtained by a large amount of information signals) and network traffic overhead (which can be limited by limiting the amount of information signals).

Preferably, each mobile device generates useful information also in Idle mode. Information retrieved/determined in Idle mode are locally stored in a device's buffer, and then transmitted to the network—through information signals—as soon as the device switches to the Connected state.

In a preferred embodiment, the information signals SIG are MDT (Minimization of Drive Test) signals. Such technology is standardized by ETSI and disclosed in technical specification 3GPP TS 37.320; for example, version 15.0.0 (2018 June) can be taken into consideration. Said technical specification is herein incorporated by reference.

For example, each information signal SIG can present the following logical structure:

| Field | Description | Format |
|---|---|---|
| CALL_ID/Session_ID | Session identifier | Positive integer |
| DATE | Date on which the | YYYY-MM-DD |
| | information signal is sent | |
| | to the eNodeB | |
| TIME | Time at which the | hh:mm:ss.sss |
| | information signal is sent | |
| | to the eNodeB | |
| TIMESTAMP | Date and time at which | YYYY-MM-DD |
| | data are detected | hh:mm:ss.sss |
| HOME_NETWORK | PLMN of tracing cell | Positive integer |
| MTMSI | MME TMSI, temporary | Positive integer |
| | identifier | |
| LATITUDE | Latitude (WGS84) | dd.dddddd |
| LONGITUDE | Longitude (WGS84) | ddd.dddddd |
| UNCERT_SEM_MNR | Uncertainty | m |
| | ellipse/ellipsoid semi- | |
| | minor axis | |
| UNCERT_SEM_MJR | Uncertainty | m |
| | ellipse/ellipsoid semi- | |
| | major axis | |
| ORIENT_MJR_AXIS | Semi-major axis | ° |
| | orientation with respect | |
| | to geographic North | |
| ALTITUDE | Height above sea level | m |
| LATITUDE_10 | Central latitude of the | dd.dddddd |
| | pixel in a 10 m × 10 m | |
| | grid (WGS84) | |
| LONGITUDE_10 | Central longitude of the | ddd.dddddd |
| | pixel in a 10 m × 10 m | |
| | grid (WGS84) | |
| LATITUDE_25 | Central latitude of the | dd.dddddd |
| | pixel in a 25 m × 25 m | |
| | grid (WGS84) | |
| LONGITUDE_25 | Central longitude of the | ddd.dddddd |
| | pixel in a 25 m × 25 m | |
| | grid (WGS84) | |
| LATITUDE_50 | Central latitude of the | dd.dddddd |
| | pixel in a 50 m × 50 m | |
| | grid (WGS84) | |
| LONGITUDE_50 | Central longitude of the | ddd.dddddd |
| | pixel in a 50 m × 50 m | |
| | grid (WGS84) | |
| CARRIER_FREQ_ | E-UTRA Absolute | Positive integer |
| PCELL | Radio Frequency | |
| | Channel Number | |
| | (downlink) of serving | |
| | cell | |
| CELLID_PCELL | EUTRA Cell ID of the | Positive integer |
| | serving cell | |
| TIMING ADVANCE | | Positive integer |

The method comprises determining, based on the information signals SIG sent from each mobile device, a path travelled by said mobile device.

Preferably, this step comprises a preliminary correlation operation: the Applicant observes that the temporary identifier (e.g. the TMSI) and the session identifier are not always both included in each information signal SIG; in particular, the same temporary identifier (e.g. TMSI) is used for a longer time than a session identifier, but is transmitted only at the beginning of a connection, whereas the session identifier is updated (i.e. changed) at each user session. Accordingly, an operation is performed so that information signals SIG are correlated to each other, based on the temporary identifier and/or session identifier included therein. In this way, sequences of correlated data (e.g. MDT samples) can be created.

Based on the information signals SIG, sequences of data can be created; such sequences include geographical positions of each mobile device, tracked over time. From a practical point of view, geographical positions are ordered according to the reference time associated thereto; by joining (e.g. by means of a simple linear interpolation) the ordered geographical position, the path travelled by each mobile user terminal can be determined.

In an embodiment, the path of one or more mobile devices comprises different segments. Each segment is defined by a plurality of geographical positions; as said, each geographical position is associated with a respective time reference and the geographical positions are ordered based on the respective time references; in a segment, the difference between time references of each couple of consecutive geographical positions is smaller than a preset threshold.

Preferably, one or more paths include one or more joining portions which join consecutive segments.

Preferably, each segment is identified by a respective segment identifier.

Preferably, each path is identified by a respective path identifier. The path identifier is correlated with the session identifier, in that all the points belonging to a same path are associated to a same session identifier.

The Applicant observes that, in the present description, the expressions “geographical position” and “point” are used interchangeably, since each geographical position included in an information signal defines a corresponding point on the respective path.

In view of the above, a Dataset including the following data can be defined:
Path identifier (Path_ID): code uniquely identifying one path; as said, it is correlated to the session identifier;
Segment identifier (Segment_ID): code uniquely identifying each of the segments belonging to one path;
Hop: number of points forming a segment; such points are ordered from a first point to a last point; the first point is preferably indicated as Hop=0; the last point is generally referred to as “Hop max”;
Timestamp: date and time on which the data are detected;
Latitude: latitude of the position of the mobile user terminal;
Longitude: longitude of the position of the mobile user terminal.

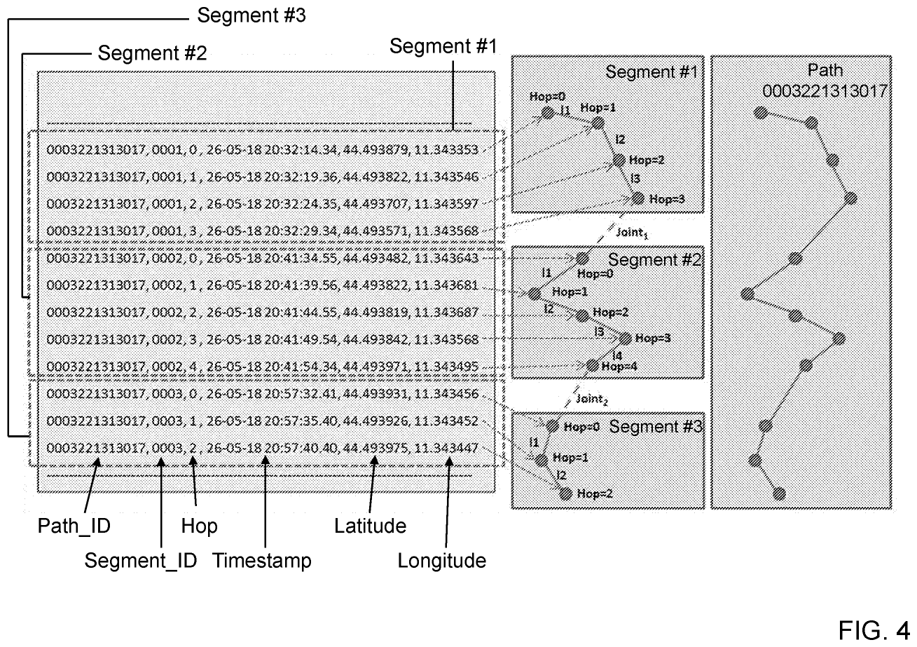

FIG. 4 schematically shows a path, with the Dataset associated thereto. It can be appreciated that the exemplary path comprises three segments (Segment #1, Segment #2, Segment #3), and two joining portions (Joint1, Joint2) which join Segment #1 with Segment #2, and Segment #2 with Segment #3, respectively.

Considering now Segment #1, for example, FIG. 4 shows that it is defined by four points (or geographical positions), identified as Hop0 . . . Hop3, respectively. In this case, “Hop max” is equal to 3. The three parts defined by each couple of consecutive points are labelled as l1, l2, l3.

Preferably, the method according to the present invention comprises a step of calculating the length of each of the segments comprised in one path.

The length of a segment can be calculated as follows:

$${L}_{Segm} = {\sum }_{h = 1}^{Hop max} {l}_{h}$$

wherein lₕ indicates the distance between the h-th point and the (h−1)-th point.

Preferably, the method according to the present invention comprises a step of calculating the length of each path.

The length of a path can be calculated as follows:

$${L}_{Path} = {\sum }_{i = 1}^{P} {L}_{{Segm}_{i}} + {\sum }_{j = 1}^{J} {L}_{{joint}_{j}}$$

wherein P is the number of segments comprised in the path, J is the number of joining portions comprised in the path, Lⱼₒᵢₙₜ_{ⱼ} is the length of the j-th joining portion.

As said, information signals SIG are sent from the mobile devices to the network; FIG. 2 shows, in addition to other entities, a Radio Access Network, RAN, 100, which can operate in this context.

RAN 100 comprises a plurality of Radio Base Stations, RBS, 110 spread over a territory so as to provide radio coverage. In particular, RBSs are present in the zone of interest Z1 and in the detection zone Z2.

For example, RAN 100 can provide radio access based on 4G or 5G technologies. The person skilled in the art will understand that the present invention is not in principle limited to these technologies, but can be implemented also with different/future radio access technologies/standards.

RBSs 110 are connected to a control structure which handles radio traffic to and from RBSs 110. The control structure, which may include both apparatuses installed at the radio base stations RBSs 110 and in remote locations, is herein generally referred to as control unit 120. The latter is per se known and will not be disclosed in detail in the following. For example, the control unit 120 may comprise a Radio Network Controller, RNC, associated with RAN 100 (e.g., in the case of a 3G network) or one or more elements of a Mobility Management Entity, MME (e.g., in the case of a 4G or 5G network). RAN 100 and control unit 120 form a radio access communications system, designated at 300 in FIG. 2.

RBSs 110 exchange radio signals with mobile devices 200 via respective wireless connections. In particular, as said, RBSs 100 receive the aforesaid information signals SIG.

According to the invention, mobile devices 200 can include both smartphones, tablets, and vehicles, typically cars, provided with WAN (Wide Area Network) connectivity. In case pedestrian traffic is to be predicted, smartphones and tablets may, for example, be taken into consideration; in case vehicle traffic is to be predicted, smartphones, tablets and WAN connected vehicles (or On Board Units of such vehicles) may be taken into consideration.

The present invention addresses two stages, which can be implemented singularly or in combination with each other, depending on the specific needs of the industrial/commercial entities involved and agreements between them.

One first stage concerns the generation of reference data for traffic condition prediction; one second stage concerns the actual prediction of traffic conditions.

Mobile devices 200 are involved in both the first and second stage. It is a priori unknown whether a certain mobile device involved in the first stage will also be involved in the second stage. Accordingly, for the sake of clarity, the mobile devices involved in the first stage will be considered different from those involved in the second stage. The mobile devices involved in the first stage are referred to as “first devices” 210, and the mobile devices involved in the second stage are referred to as “second devices” 220. In general terms, it is not excluded that one or more first devices 210 are included among the second devices 220, and/or that one or more second devices 220 are included among the first devices 210.

What has been disclosed above in connection with the generic wording “mobile device(s)”, applies to both the first devices 210 and the second devices 220.

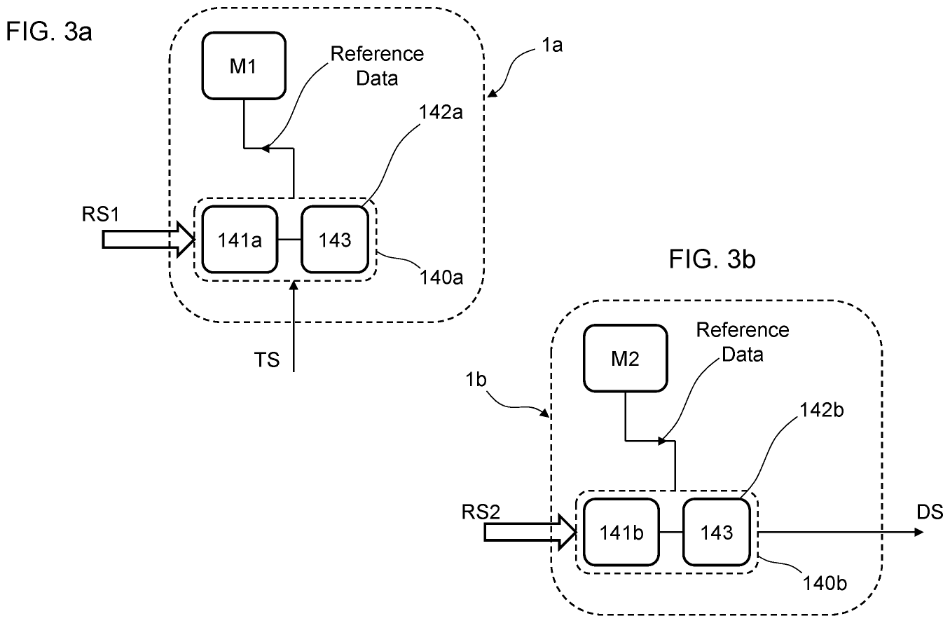

The operations regarding the first stage are preferably carried out by a system for generating reference data for traffic condition prediction, which is denoted at 1a in FIGS. 2, 3a.

System 1a comprises a first memory M1 and a first processing unit 140a, coupled to the first memory M1.

Preferably, the first processing unit 140a includes a first data collection unit 141a and a first processing module 142a; the first data collection unit 141a is configured for receiving first report signals RS1 and provide the same to the first processing module 142a.

The first report signals RS1 can be the information signals SIG sent by the first devices, or can be generated based on the information signals SIG.

The first report signals RS1 can be MDT signals, or can be generated based on MDT signals.

In order to generate reference data for traffic condition prediction, the first processing unit 140a—and in particular the first processing module 142a—is configured for detecting the presence of mobile devices (first devices 210) in the detection zone Z2.

Such detection is based on the first report signals RS1 received by the first processing unit 140a—and in particular by the first processing module 142a.

The Applicant observes that, in the context of the present invention, identity of the users associated with mobile devices 200 is not used, as the data leveraged by the invention are substantially position of the devices, measurements correlated to the wireless connection between the wireless devices and the RAN 100, and time references associated with the measurements. Accordingly, no privacy issues arise from the implementation of the present invention.

The first report signals RS1 received by the processing unit 140a, and in particular by the first processing module 142a, are processed, so as to calculate movement features for each first device 210.

In particular, based on the information included in the first report signals RS1 (position and time reference, as well as the identifier), movement features for each first device 210 are calculated.

For example, the movement features can include a trajectory followed by the first device 210 in the detection zone Z2. The trajectory can be calculated as disclosed above, based on aforementioned segments and paths.

In an embodiment, the trajectory of each first device can be advantageously employed for verifying that the first device 210 is actually in the detection zone Z2 and keeps moving in the detection zone Z2.

The movement features can also comprise a speed at which each first device 210 moves in the detection zone Z2.

Based on said one or more movement features of said first devices, the first processing unit 140a (and in particular the first processing module 142a) calculates one or more predictors.

The one or more predictors are associated to the time references and the geographical positions included in the first report signals RS1.

In practical terms, the predictors (calculated with reference to the detection zone Z2) are parameters which are defined and computed so as to be correlated to the traffic conditions in the zone of interest Z1, after a certain time. Accordingly, as will be clearer in the following, the predictors can be advantageously used to predict traffic conditions in the zone of interest Z1.

The one or more predictors can include, for example, the average speed and/or the variance of the speed of the first devices at a certain time (identified by the time references included in the report signals used to calculate the reference data).

In accordance with the invention, information concerning the objective traffic condition in the zone of interest Z1 are available, for generating the reference data necessary for prediction.

To this aim, a traffic signal TS is received by the first processing unit 140a (and in particular by the first processing module 142a), representative of an objective traffic condition in the zone of interest Z1. The objective traffic condition has occurred (or occurs) after a determined time with respect to said one or more time reference associated to the predictor(s). For example, the determined time can be comprised between 15 minutes and 20 minutes. It is anyway envisaged that also different time values can be employed for said determined time, depending on the specific implementations and needs.

The traffic signal TS can be in any suitable form, provided that it conveys information regarding the objective traffic condition in the zone of interest Z1 at a certain time. For example, the traffic signal TS can be inputted by a human operator, based on data received through information channels. In addition or as an alternative, the traffic signal TS can be obtained by automatic/software-implemented techniques, based on detections by “traffic cameras” or other detection systems.

The traffic conditions can, in general, be expressed by means of two or more labels.

For example, labels can be like “high”, “low” (in a two-label configuration) or like “flowing”, “heavy”, “congested” (in a three-label configuration).

From a practical point of view, the objective traffic condition represents the traffic condition that is actually present in the zone of interest Z1 at a certain moment. The one or more predictors represent the movement of mobile devices (representative of pedestrians or vehicles) at a certain distance from the zone of interest Z1, at a certain time before the objective traffic condition occurs.

According to the invention, the first processing unit 140a (and in particular the first processing module 142a) determines reference data, based on the calculated predictors and the objective traffic condition. The reference data correlate the predictors and the objective traffic condition.

In an embodiment, a statistical process can be used for calculating the reference data.

In an embodiment, a machine learning tool 143, installed at the first processing unit 140a (and in particular at the first processing module 142a), can be used for calculating the reference data. In this case, the machine learning tool 143 is trained by providing in input the one or more predictors in association with the objective traffic conditions in the zone of interest; after a suitable time and amount of training data, the machine learning tool will have defined its inner operation (for example, determining proper weights to be given to “synapses”, i.e. connections between “neurons” in artificial neural networks). The reference data thus represent the configuration of the trained machine learning tool 143.

The reference data are the stored in the first memory M1, to be subsequently used in the second stage, i.e. the actual prediction stage.

It has to be noted that reference 143 in FIG. 3a denotes the machine learning tool, the latter being in the training stage (first stage).

As said above, a second stage addressed by the present invention is the prediction of traffic conditions.

The operations of the second stage are carried out by a system for predicting traffic conditions, denoted at 1b in FIGS. 2, 3b.

The technique is based on a detection operation performed on the detection zone Z2, and a calculation/prediction made with reference to the zone of interest Z1.

System 1b comprises a second memory M2 and a second processing unit 140b, coupled to the second memory M2.

Preferably, the second processing unit 140b includes a second data collection unit 141b and a second processing module 142b; the second data collection unit 141b is configured for receiving second report signals RS2 (disclosed in the following in greater detail) and provide the same to the second processing module 142b.

In the second memory M2, reference data are stored.

The reference data correlate predictors, associated to possible movement features of mobile devices in the detection zone Z2 at a first time, with possible traffic conditions in the zone of interest Z1 at a second time. The second time occurs after a determined time with respect to the first time.

Preferably, the reference data are calculated according to the aforesaid first stage.

In an embodiment, the first and second memory M1, M2 can be the same storage device.

In an embodiment, the reference data, which are stored in the first memory M1 in the first stage, are transmitted or moved so as to be stored in the second memory M2.

The presence of a plurality of second devices 220 is detected in the detection zone Z2.

As said, the second processing unit 140b, and in particular the second processing module 142b, receives second report signals RS2.

The second report signals RS2 can be the information signals SIG generated by the second devices 220, or can be generated based on such information signals SIG.

The second report signals RS2 can be MDT signals, or can be generated based on MDT signals.

Based on the geographical position, time reference and identifier, the second processing unit 140b, and in particular the second processing module 142b, calculates one or more movement features of second devices 220.

Such movement features may include a trajectory followed by the second mobile device and/or a speed at which the second device moves along in the detection zone Z2. The trajectory can be determined based on segments/paths as disclosed above.

As a function of the movement features of the second devices, the second processing unit 140b, and in particular the second processing module 142b, calculates detection data.

The detection data correspond to the aforesaid predictors. In practical terms, the detection data and the predictors are the same parameters, the only difference being that such parameters have been labelled as “predictors” in the first stage, and “detection data” in the second stage.

The detection data are associated to the time references and geographical positions included in the second report signals RS2 used for calculating the same detection data.

Preferably, detection data may include an average speed of said second devices 220 and/or a variance of the speed of said second devices 220.

The detection data are processed based on the reference data, thereby obtaining a prediction of a traffic condition in the zone of interest Z1, for a time occurring after a determined time with respect to the time references included in the second report signals RS2.

The prediction can be made by the aforesaid machine learning tool 143, installed at the second processing unit 140b (and in particular at the second processing module 142b). Such machine learning tool 143, after having been trained in the first stage, is now used in the second stage in order to make traffic predictions.

It has to be noted that reference 143 in FIG. 3b denotes the machine learning tool, the latter being in the operative prediction stage (second stage).

Then the second processing unit 140b (and in particular the second processing module 142b) is configured to generate a data signal DS, representative of said predicted traffic condition.

In an embodiment, the data signal DS is sent to one or more displays installed in an area associated with the detection zone Z2.

In addition or as an alternative, the data signal DS is sent to mobile devices in an area associated with said detection zone Z2. Such mobile devices can include, be included in, or be completely distinct from the second devices 220: it depends on the dimensions and position of the area associated with the detection zone Z2, and on the movement of the second devices 220.

The area in which the display(s) is/are installed and the area in which the mobile devices receive the data signal DS can be the same area or different areas. Such areas (be they different or the same) are associated with the detection zone Z2 in the sense that they can be in the proximity of, partly included in, entirely included in, partly including or entirely including the detection zone Z2. In practical terms, such areas are areas in which it may be helpful and useful provide people with information concerning the prediction of traffic in the zone of interest Z1. For example, in case vehicle traffic on a highway is considered, the detection zone Z2 can be 40 km from the zone of interest Z1, and the area in which displays are installed (and can receive the data signal DS) and/or the mobile devices receive the data signal DS can be spread along such 40 km stretch.

In an embodiment, the data signal DS is sent to a traffic management system associated with the zone of detection Z2 and/or with the zone of interest Z1. For example, the traffic management system can be installed in the zone of interest Z1. For example, the traffic management system can be installed in the zone of detection Z2 and/or in an area close thereto. From a practical point of view, the traffic management system operates in an area which is deemed to influence the traffic in the zone of interest Z1.

For example, the traffic management system can include one or more traffic lights (to form a traffic lights network, especially for regulation of vehicle traffic) and/or one or more turnstiles (or gates), especially for regulation of pedestrian traffic. Preferably, the traffic management system is provided with a controller; the data signal DS can be sent to such controller, so that the latter can regulate the traffic (by means of said traffic lights, turnstiles/gates and/or other equivalent equipment) based on the traffic prediction included in the data signal DS. In the case of traffic lights, the controller is preferably provided with suitable algorithms which, for example, set to “green” or “red” for a longer time the traffic lights installed along directions which are determined to be helpful in order to reduce traffic in the zone of interest Z1.

In an embodiment, provision is made to determine a suggested speed for mobile devices (which can then be reflected into a suggested speed for vehicles) in an area associated with the detection zone Z2. Such suggested speed is included in the data signal DS, so that it can be displayed on said display(s) and/or be displayed on displays of the mobile devices.

In case of connected vehicles, it is envisaged that the vehicle control system can be configured to receive the data signal DS including the suggested speed, possibly display it on a vehicle's display and possibly regulate the vehicle's speed according to the suggestion included in the data signal DS.

The Applicant observes that the suggested speed can be calculated in a per se known manner, in order to reduce the risk of congested traffic in the zone of interest Z1.

The Applicant also notes that different suggestions can be provided to vehicles at different distances from the zone of interest Z1, again with the aim of preventing the (predicted) traffic in the same zone of interest Z1.

In an embodiment, possible traffic conditions in the zone of interest Z1 are represented by two or more labels. Obtaining a prediction of the traffic condition thus can comprise selecting a label among said two or more labels.

As said above, a two-label solution (“high”, “low”) can be implemented, for example; a different solution may provide for three labels (“flowing”, “heavy”, “congested”).

It has to be noted that, in the above disclosure, the system 1a for generating reference data for traffic condition prediction and the system 1b for predicting traffic conditions have been presented separately since, in line of principle, they can operate independently from each other, and different entities can take care of the first stage and the second stage, respectively.

FIG. 2 shows a preferred embodiment, wherein the operations of both the first and second stage are carried out by a single processing unit 140 (in which the first and second processing units 140a, 140b are thus collapsed), and one single memory M is used (in which the first and second memories M1, M2 are collapsed). In greater detail, the processing unit 140 comprises a data collection unit 141 (which collects both the first and second report signals RS1, RS2) and a processing module 142 (which performs the operations carried out by both the first and second processing module 142a, 142b; in particular, the processing module 142 can be implemented as the aforementioned machine learning tool 143).

In the above description, reference has been to one detection zone only. The Applicant notes that the invention also applies to scenarios wherein two or more detection zones are considered, in particular different zones from which traffic converges into one path/route to the zone of interest.

In view of the above, the Applicant observes that a possible scenario according to which the present invention can be implemented is the following:
a telecommunications operator receives the report signals (as said, for example, MDT signals), i.e. the first report signals RS1 and the second report signals RS2;
a first industrial/commercial entity, based on the first report signals RS1 provided by the telecommunications operator, sets up and configures the prediction model (i.e. determines the reference data);
a second industrial/commercial entity, receives the configured prediction model from the first industrial/commercial entity and, based on the second report signals RS2 provided by the telecommunications operator, using the configured prediction model, performs the traffic prediction (i.e. generates the data signal DS).

### Example #1

In a first example, the Applicant has tested the implementation of the invention for pedestrian traffic, in pedestrian zones of a city (i.e. zones in which, apart limited exceptions, the access of motor vehicles is not permitted).

The zone of interest is defined as a place wherein a crowd of tourists is often present; the detection zone is an area crossed by a significant portion of the people directed to the zone of interest. The distance between the zone of interest and the zone of detection is approximately 2 km.

Predictive model SVM (Support Vector Machine) has been used; two levels of traffic have been defined (with respective labels “high”, “low”).

Detection of MDT signals were made for several days, in different time intervals in each day.

Several predictors were tested; number of people and speed variance resulted as the most accurate.

Prediction times equal to 10, 20 and 30 minutes were considered. A prediction time of 20 minutes was finally determined to be the most appropriate.

### Example #2

In a second example, the Applicant has tested the implementation of the invention for vehicle traffic on a highway.

The zone of interest is defined as a particular area wherein quite often, especially at a certain time of each day, the traffic is very congested; the detection zone is a 40 km stretch of highway leading to the zone of interest.

Predictive model KNN (K-Nearest Neighbor) has been used, with k=3; three levels of traffic have been defined (with respective labels “flowing”, “heavy”, “congested”).

Detection of MDT signals were made for a couple of weeks, in different time intervals in each day.

Several predictors were tested; the speed average resulted as the most accurate.

Prediction time equal to 15 minutes has been successfully tested.

1. Method for generating reference data for traffic condition prediction, comprising:
determining a zone of interest;
determining a detection zone, associated to said zone of interest;
detecting the presence of a plurality of first devices in said detection zone, said first devices being mobile user terminals;
for each of said first devices:
receiving over time a plurality of first report signals, each report signal including: a geographical position of said first device, a time reference associated with said geographical position and at least one of a user-related identifier and a session identifier;
based on said first report signals, determining one or more movement features correlated to movement of said first device in said detection zone;
based on said one or more movement features of said first devices, calculating one or more predictors, associated to said time references and said geographical positions;
receiving a traffic signal, representative of an objective traffic condition in said zone of interest, said objective traffic condition having occurred after a determined time with respect to said one or more of time references;
determining reference data, based on said calculated predictors and said objective traffic condition, for correlating said predictors and said objective traffic condition;
storing said reference data in a first memory.

2. Method according to claim 1, wherein said first report signals are Minimization of Drive Test, MDT, signals or are generated based on MDT signals.

3. Method according to claim 1, wherein said one or more movement features include a trajectory along which each first device moves and/or the speed at which each first device moves in said detection zone.

4. Method according to claim 1, wherein said one or more predictors comprise one or more of the following:
an average speed of said first devices;
a variance of the speed of said first devices.

5. Method according to claim 1, wherein the correlation between said one or more predictors and possible traffic conditions in said zone of interest is established via a machine learning tool.

6. Method for predicting traffic conditions, comprising:
determining a zone of interest;
determining a detection zone associated to said zone of interest;
providing, in a memory, reference data, said reference data correlating predictors associated to possible movement features of mobile devices in said detection zone at a first time with possible traffic conditions in said zone of interest at a second time, said second time occurring after a determined time with respect to said first time;
detecting the presence of a plurality of second devices in said detection zone, said second devices being mobile user terminals;
for each of said second devices:
receiving over time a plurality of second report signals, each second report signal including: a geographical position of said second device, a time reference associated with said geographical position and at least one of a user-related identifier and a session identifier;
based on said second report signals, determining one or more movement features correlated to movement of said second device in said detection zone;
based on said one or more movement features of said second devices, calculating detection data corresponding to said predictors, associated to said time references and said geographical positions;
processing said detection data based on said reference data, obtaining a prediction of a traffic condition in said zone of interest for a time occurring after a determined time with respect to the time references included in said second report signals;
generating a data signal representative of said predicted traffic condition.

7. Method according to claim 6, wherein said second report signals are Minimization of Drive Test, MDT, signals or are generated based on MDT signals.

8. Method according to claim 6, wherein said one or more movement features include a trajectory along which each second device moves and/or the speed at which each second device moves in said detection zone.

9. Method according to claim 6, wherein possible traffic conditions in said zone of interest are represented by two or more labels, wherein obtaining a prediction of the traffic condition comprises selecting a label of said two or more labels.

10. Method according to claim 6, wherein said detection data comprise one or more of the following:
an average speed of said second devices;
a variance of the speed of said second devices.

11. (canceled)

12. Method according to claim 6, comprising at least one of the following:
sending said data signal to a display installed in an area associated with said detection zone;
sending said data signal to mobile devices in said detection zone;
sending said data signal to a traffic management system associated with said zone of detection and/or with said zone of interest.

13. Method according to claim 6, comprising:
determining a suggested speed for mobile devices in the detection zone;
including said suggested speed in said data signal.

14. System for generating reference data for traffic condition prediction, comprising:
a first memory;
a first processing unit, coupled to said first memory, and configured for:
determining a zone of interest;
determining a detection zone associated to said zone of interest;
detecting the presence of a plurality of first devices in said detection zone, said first devices being mobile user terminals;
for each of said first devices:
receiving over time a plurality of first report signals, each first report signal including: a geographical position of said first device, a time reference associated with said geographical position and at least one of a user-related identifier and a session identifier;
based on said first report signals, determining one or more movement features correlated to movement of said first device in said detection zone;
based on said one or more movement features of said first devices, calculating one or more predictors, associated to said time references and said geographical positions;
receiving a traffic signal, representative of an objective traffic condition in said zone of interest, said objective traffic condition having occurred after a determined time with respect to said one or more of time references;
determining reference data, based on said calculated one or more predictors and said objective traffic condition, for correlating said one or more predictors and said objective traffic condition;
storing said reference data in said first memory.

15. System for predicting traffic conditions, comprising:
a second memory;
a second processing unit, coupled to said second memory, and configured for:
determining a zone of interest;
determining a detection zone associated to said zone of interest;
wherein said second memory contains reference data, said reference data correlating predictors associated to possible movement features of mobile devices in said detection zone at a first time with possible traffic conditions in said zone of interest at a second time, said second time occurring after a determined time with respect to said first time;
said second processing unit being further configured for:
detecting the presence of a plurality of second devices in said detection zone, said second devices being mobile user terminals;
for each of said second devices:
receiving over time a plurality of second report signals, each second report signal including: a geographical position of said second device, a time reference associated with said geographical position and at least one of a user-related identifier and a session identifier;
based on said second report signals, determining one or more movement features correlated to movement of said second device in said detection zone;
based on said one or more movement features of said second devices, calculating detection data corresponding to said one or more predictors, associated to said time references and said geographical positions;
processing said detection data based on said reference data, obtaining a prediction of a traffic condition in said zone of interest at a time occurring after a determined time with respect to the time references included in said second report signals;
generating a data signal representative of said predicted traffic condition.
